(19) United States
(12) Patent Application Publication
(10) Pub. No.: US 2011/0313860 A1
(43) Pub. Date: Dec. 22, 2011

(54) METHODS FOR RENDERING ADVERTISEMENT MESSAGES BY THE USE OF A MOBILE COMMUNICATION DEVICE

(76) Inventor: Yang Pan, Shanghai (CN)

(21) Appl. No.: 13/204,682

(22) Filed: Aug. 7, 2011

Related U.S. Application Data
(63) Continuation-in-part of application No. 12/202,222, filed on Aug. 30, 2008.

(51) Int. Cl. G06Q 30/00

(52) U.S. Cl. 705/14.58; 705/14.64

(57) ABSTRACT

A method is disclosed for rendering advertisement messages to a user of a mobile device according to the user's commercial interests determined based upon contents of voice communication. A display screen of a mobile device is used to present an advertisement message during or after a voice communication. The contents of the voice communication are recorded and analyzed. According to one aspect of the present invention, the user's commercial interest is determined by ranking frequency of appearance of keywords. According to another aspect, the user's commercial interest is determined by ranking an increased rate of appearance of the keywords over a period of time.

### CROSS-REFERENCE TO RELATED APPLICATIONS

The present disclosure is a Continuation-in-Part of the U.S. patent application Ser. No. 12/202,222.

### BACKGROUND

1. Field of Invention

This invention relates generally to advertising. More specifically, the invention relates to methods and systems for providing advertisements by the use of mobile communication devices.

2. Description of Prior Art

To provide information and communication services to various users, mobile devices with computing and communication means are widely used today. Many of these mobile devices are kept in a functioning state even when the user is not using the device in order to keep the device in touch with the communication network. Many electronic devices simply display an idle screen while the device is not being used. Many mobile devices display a blanket screen to conserve energy provided by a battery. A typical idle screen for a mobile computing and communication device may include such information as radio signal strength, battery charge level, current date, time of day.

Such displays provide no or little information to the user who, however, has to glance at the display whenever he/she operates the device. It would be desirable to display advertisement messages so that it is nearly guaranteed that the user sees the messages.

U.S. Pat. Nos. 5,913,040, 6,317,789, 6,539,429 to Rakavy et al disclosed prior arts to utilize idle screen of a mobile device to display advertisement messages, which are delivered to the user's device without user's notification. The messages are displayed preferably as a screen saver. U.S. Pat. No. 6,363,419 to Martin et al disclosed a method to display useful or commercial information on an idle screen. The idle content screen is switched to a default display screen when a user's input action is received. The default display screen is the gateway for the user to navigate to various application menus of the mobile device. US patent application 2004/0077340 by Forsyth and the application 2006/0156256 by Lee disclosed similar arts to use idle screens for displaying commercial information with the user's programmability on the displayed contents. In U.S. Pat. No. 7,369,864 to Vaananen, an art is disclosed by using of electronic short messaging method to deliver advertisement messages. The message is shown to the user automatically, and he or she may delete it or receive further information on it with one single press of a dedicated key.

There are two disadvantages associated with using an idle screen for presenting an advertisement message. First, a user may not in a mode to view the message displayed on the idle screen when he or she receives a call. The situation becomes worse if the user needs to apply additional input actions to get rid of messages displayed and to receive the call. Further, the message displayed using the idle screen may consume additional power from the battery, in particularly, if the displayed messages include colorful pictures or multimedia messages. Although significant progress has been made with regards to the battery technology in recent years, the reduction of power consumption continues to be a key challenge for mobile devices. The utilization rate of a mobile device is low for a typical user. It wastes battery power if the displayed messages are not viewed by the user.

Accordingly, it is an object of the present invention to provide a method for rendering advertisement messages on a display screen of a mobile device during and after a voice communication. The user notices the message immediately after the termination of the voice communication. There is no required user action if the user is not interested in the message and the message is deleted after a predetermined period of time. If the message is indeed selected by the user for a further review, more user selectable icons are then displayed on the screen for the user's selection of the next level of details.

It is another object of the present invention that the message rendered is based upon contents of the voice communication, from which the user's commercial interests may be derived.

It is yet another object of the present invention that the message rendered is based upon a combination of the content of the voice communication and a current location of the user.

It is still another object of the present invention that the user's commercial interests are determined by comparing the words used in the voice communication with the ones included in a file representing a typical user's commercial interests. The words used are ranked based upon the frequency of appearance and the user's commercial interests may be derived. By doing so, the advertisement broker operating an advertisement server accesses only the highest ranked words but not sentences. Thus a targeted advertisement can be rendered without risking exposing a user's privacy.

### SUMMARY OF THE INVENTION

To more effectively use the display screen of mobile devices, the present invention introduces methods for rendering targeted advertisement messages to a user during and after a voice communication. The device displays an advertisement message when a user is being engaged in a voice communication. The user views the message immediately after the termination of the voice communication. No additional user input action is required if the user is not interested in the message.

According to one embodiment, the message is displayed after the device receives a signal that the user is engaged in a voice communication or a “call”. The user typically clicks a button related to the termination of the call after the completion of the call. It is likely that the user notifies the message displayed and he or she may decide to leave the message un-touched or to view the message further. In the present invention, a touch-screen type of display is used as an exemplary case for illustration. In the present embodiment, the user touches the screen displayed with the message after the termination of the call if the advertisement message intrigues him or her. The next level of detailed information is then displayed after receiving the user's input action. Alternatively, a plurality of user selectable items represented by icons is displayed for the user's selection to view the information with further details. In another aspect of the invention, the displayed icons may include one specific icon representing other advertisement messages in the folder. If the user selects the icon, a plurality of advertisement messages is displayed on the screen for the user's selection and review.

According to another aspect of the present invention, the content of the voice communication is analyzed by a software program embedded in the device. The words involved in the communication are collected and converted into text form by using of a software module for the voice recognition. The collected words are compared with a list of words in a stored file representing commercial interests of a typical user. A successful match event is established if a word from the voice communication is matched with a word in the file. The words are then ranked based upon the frequency of the successful matches. A user's commercial interests are determined based upon such a ranking process. A targeted advertisement message is then displayed after the call is terminated.

### BRIEF DESCRIPTION OF THE DRAWINGS

For a more complete understanding of the present invention and its various embodiments, and the advantages thereof, reference is now made to the following description taken in conjunction with the accompanying drawings, in which:

FIG. 1 is a schematic diagram of a server used by an advertisement broker receiving real time advertisement messages from advertisers and sending to a plurality of mobile devices through communication networks.

FIG. 2 is a schematic diagram of a mobile communication device according to one embodiment, an “advertisement message manager” (software module) is used to control the operations of rendering advertisement messages and a “keyword analyzer” (software module) including a voice recognition software module and a data file named “keyword library” is used to determine a user's commercial interests based upon contents of the voice communication.

FIG. 3 is a schematic diagram of a series of display screens showing the changes from a default screen for the mobile device in a calling status to a screen with a displayed message and further to a screen with more user selectable icons for the next level of details.

FIG. 4 is a flow diagram of an embodiment for rendering an advertisement message to a display screen of the mobile device during and after the voice communication.

FIG. 5 is a schematic diagram of a series of display screens showing the changes from a default screen for the mobile device in a calling status to a screen with a displayed message and further to a screen with more user selectable icons for the next level of detailed information and an icon for other advertisement messages.

FIG. 6 is a flow diagram of another embodiment for rendering advertisement messages to a display screen of the mobile device during and after the voice communication, wherein the displayed messages include an icon for other advertisement messages.

FIG. 7 is a flow diagram of still another embodiment for rendering advertisement messages to a display screen of the mobile device during and after the voice communication—and the displayed message is determined based upon the analysis of contents of the voice communication.

FIG. 8 is a flow diagram of the “keyword analyzer” determining a user's commercial interest by comparing words extracted from the voice communication with a list of words in the “keyword library”.

FIG. 9 is a schematic diagram of the mobile communication device according to another embodiment. A keyword memory file is included in the device to store extracted keywords from the voice communications for a predetermined period of time.

FIG. 10 is a flow diagram illustrating a process that an advertisement message is delivered based on ranking of keywords according to their frequency of appearance over a predetermined period of time.

FIG. 11 is a flow diagram illustrating a process that an advertisement message is delivered based on ranking of keywords according to an increased rate of appearance over a predetermined period of time.

### DETAILED DESCRIPTION

References will now be made in detail to a few embodiments of the invention, examples of which are illustrated in the accompanying drawings. While the invention will be described in conjunction with the particular embodiments, it will be understood that it is not intended to limit the invention to the described embodiments. To the contrary, it is intended to cover alternatives, modifications, and equivalents as may be included within the spirit and scope of invention as defined by the appended claims.

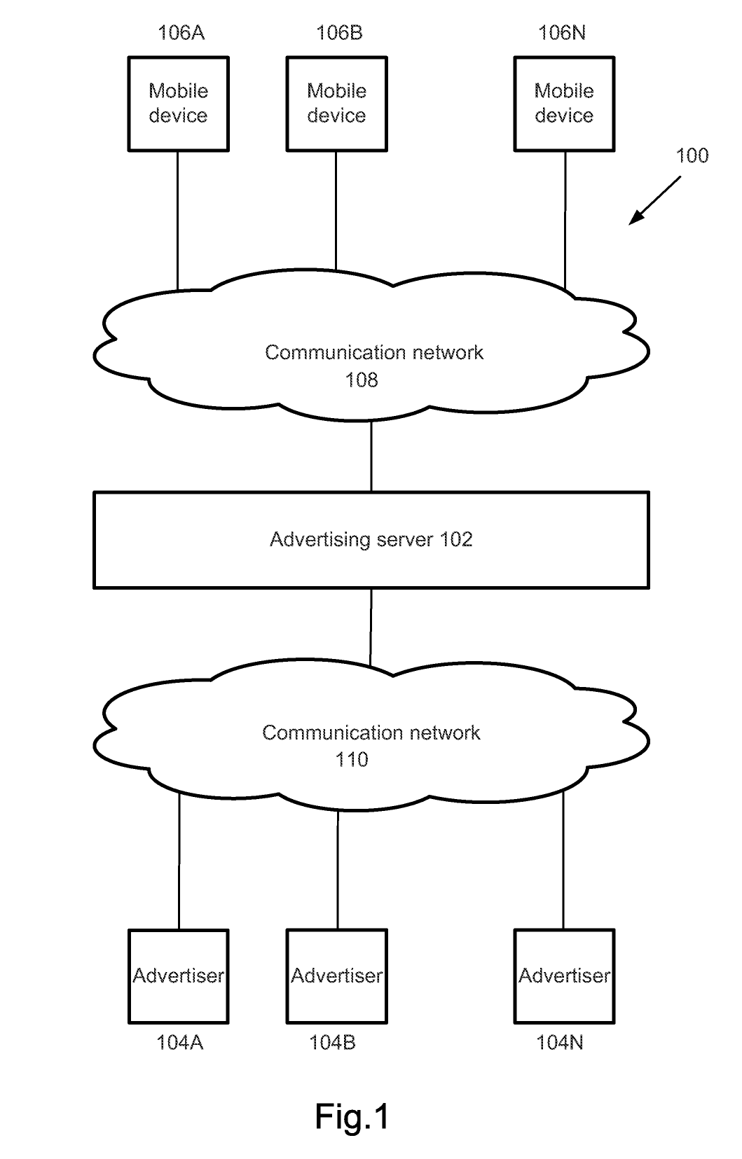

FIG. 1 is a schematic diagram of an exemplary communication system 100 for distributing advertisement messages. An advertising server 102 is used by an advertisement broker receiving real time advertisements from advertisers 104 and sending to a plurality of electronic devices 106. The electronic devices 106A, 106B, 106N can take various forms such as, for example, it can be a mobile computing and communication device which a user is carrying with. In various embodiments, each electronic device may communicate with an advertising server 102 through a communication network 108. The communication network can take various forms such as the internet, a W-LAN and other suitable communication networks. A plurality of advertisers 104A, 104B, and 104N may also communicate with the advertising server 102 over a communication network 110. In various embodiments network 108 and 110 may be the same network, however, in various other embodiments, the network 108 and 110 may be different networks. In various embodiments, the advertisers 104A, 104B, 104N may communicate with the advertising server 102 for a number of reasons, including, purchasing advertisement space and uploading advertisement messages. In the present invention, the advertisement messages from the advertisers to the advertising server are updated continuously on a real time base.

It should be noted that system depicted in FIG. 1 shows a single advertising server 102 for ease of illustration purpose only. Various embodiments may use multiple servers in a manner that is either apparent or transparent to the communication system and its users.

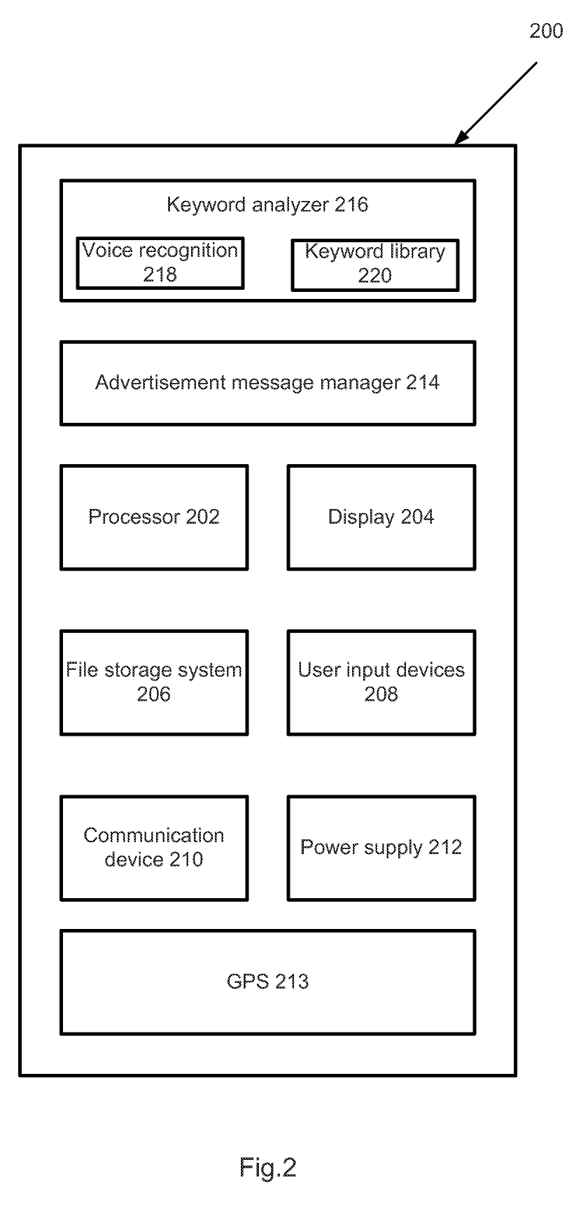

We take a mobile computing and communication device as an exemplary case to illustrate the present invention. As shown in FIG. 2, the mobile device 200 may comprise a processor 202 to control operations of the device, a display screen 204, such as, for example, a Liquid Crystal Display (LCD) screen and a file storage system 206. The file storage system 206 is typically a semiconductor flash memory device or a plurality of flash memory devices or a magnetic storage means as a hard disk driver. The file storage system may also include a cache to improve the data access time. The mobile device 200 further comprises a user input device or devices 208 as keys, touch pads or a rotational user interface as used in iPod from Apple Inc Cupertino Calif. The user input device can be integrated at least partially with the display screen in a specific implementation related to touch-screen type of display. A touch-screen is a display which can detect the location of touches within display area, usually performed either with the human hand or a stylus. The device 200 also includes a communication device module 210 to connect to the communication network. The communication network can take forms as a telephony network or the internet. In one implementation, the mobile device is GSM mobile station. In other implementations, the mobile devices may be a UMTS, WAP, Teldesic, Inmarsat, Iridium, GPRS, CDMA, WCDMA mobile station. The mobile device may be connectable to a wireless internet network. The device is powered by a power supply 212 such as a battery. A GPS unit 213 may also be included in the mobile device 200 to determine the location of the device. Recently, GPS has been developed to the point where they are very inexpensive to implement in a mobile device. The employment of the GPS can assist the server to deliver location-based advertisement messages to the user.

A software module “advertisement message manager” 214 is used to control the operations for receiving and displaying advertisement messages delivered from the advertising server. The device being characterized in that, the software module is arranged to identify in coming advertisement messages, store the messages in the file system or display at least portion of messages directly on the display screen.

In various embodiments of the invention, advertisements may include text, graphics, video, audio and multimedia messages. It should be appreciated that while advertisement messages are used herein as exemplary embodiments of the invention, any document may be used in accordance with the various embodiments. For instance, documents such as advertisements, content pages, search results, emails, IM messages, audio content or files, video contents or files, other data or applications that may reside on one or several of computer systems, or other definable concepts or content may be used. Thus although the use of advertisement messages are described herein as examples, other documents such as web pages may be targeted to viewers and displayed in accordance the various embodiments, e.g. as described herein with respect to advertisement messages.

It should be understood that an advertisement message as used herein may comprise audio and/or video signals, static and/or dynamic images, graphics, video, film, or other content that relate to one or more products, services, and/or entities, such as commercial entities. Advertisement messages may also comprise various visual features, including animation, sound etc., and may include text, such as in a text advertisement. Thus, the term “advertisement message” is used herein in its broadest sense to include any content or object intended for observation, use, or consumption by one or more persons for the purpose of marketing or promoting a product or service. While, advertisement messages are used for exemplary purpose, it should be understood that any audio and/or video content, such as television programming, may be used with the systems and methods described herein.

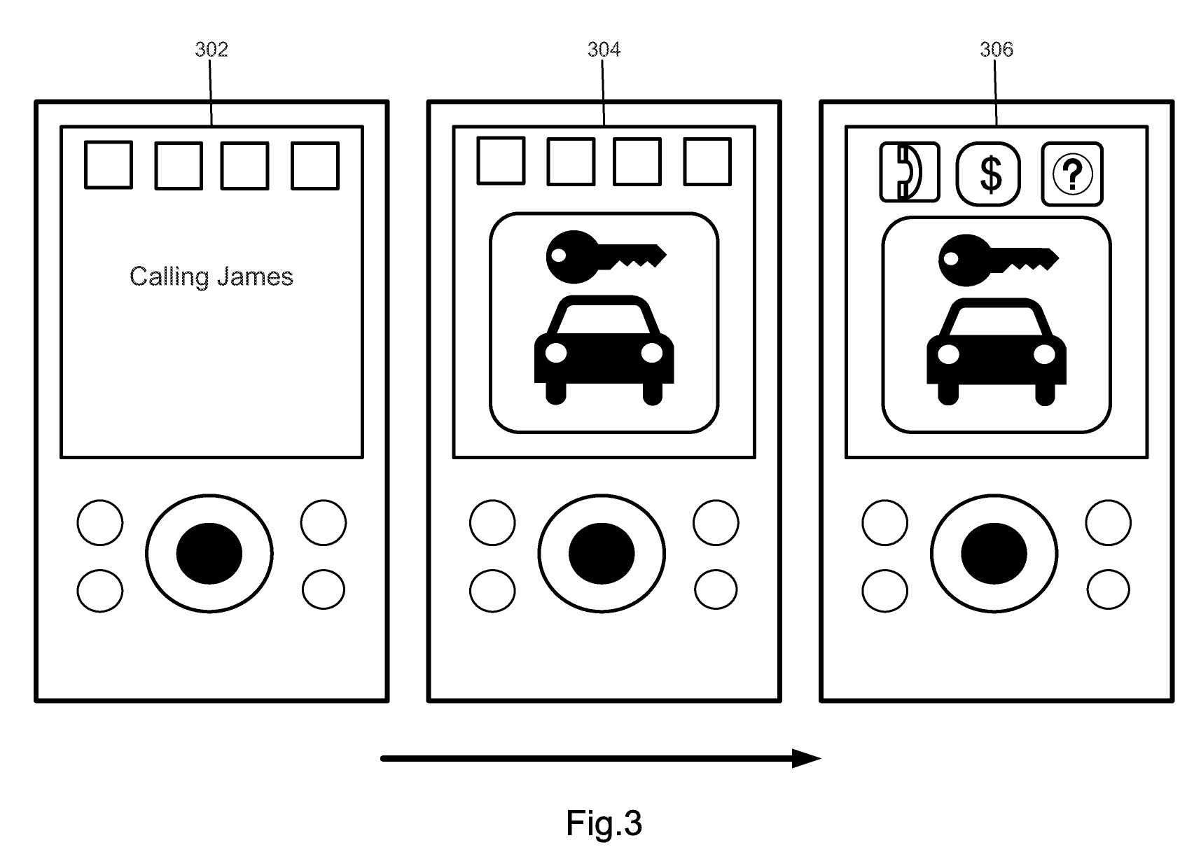

FIG. 3 is a schematic diagram of a series of display screens showing the changes from a default screen for the mobile device in a calling status to a screen with a displayed message and further to a screen with more user selectable icons for the next level of detailed information. An exemplary screen for a mobile device in the “calling” status is shown in 302. The screen is typically showing a calling number or a name of the one in dialogue with the user. The screen may also display a plurality of icons which are used for the default screen for the device leading to various applications. In one embodiment, an advertisement message is displayed replacing the items displayed in the standard “calling” screen as shown in 304. In one aspect of the present invention, the default icons are remained on the screen with displayed message. This arrangement allows the user to access the other applications conveniently after the call is terminated. If the user selects the message for a further review, a plurality of icons is displayed as shown in the message screen 306.

The user may choose one of the icons for receiving more detailed information about the message. A touch-screen type of display is used as an exemplary illustration. After the call is terminated by the user by clicking the button associated with the termination, the user is likely to notice the message on the screen. He or she may choose to ignore the message by simply doing nothing with regards to the message. After a predetermined period of time, the message is deleted if no user input action with regards to the message is received. In case that the user does select the message for further review such as, for example, selects the message by touching the screen of the touch-screen type of display, a plurality of icons for next level of detailed messages is displayed. In 308, exemplary icons are shown including an icon with a symbol representing a phone, an icon with a “$” and an icon with “?”. If the user selects the icon representing a phone, a connection between the user and the advertiser is established. The user may talk to the sale representative of the advertiser for further information without key-in the phone number of the advertiser. If the user selects the icon represented by a “$” symbol, the next screen may present to the user more detailed purchasing information for the products or services. The icon represented by “?” presents to user more product or service information when selected by the user.

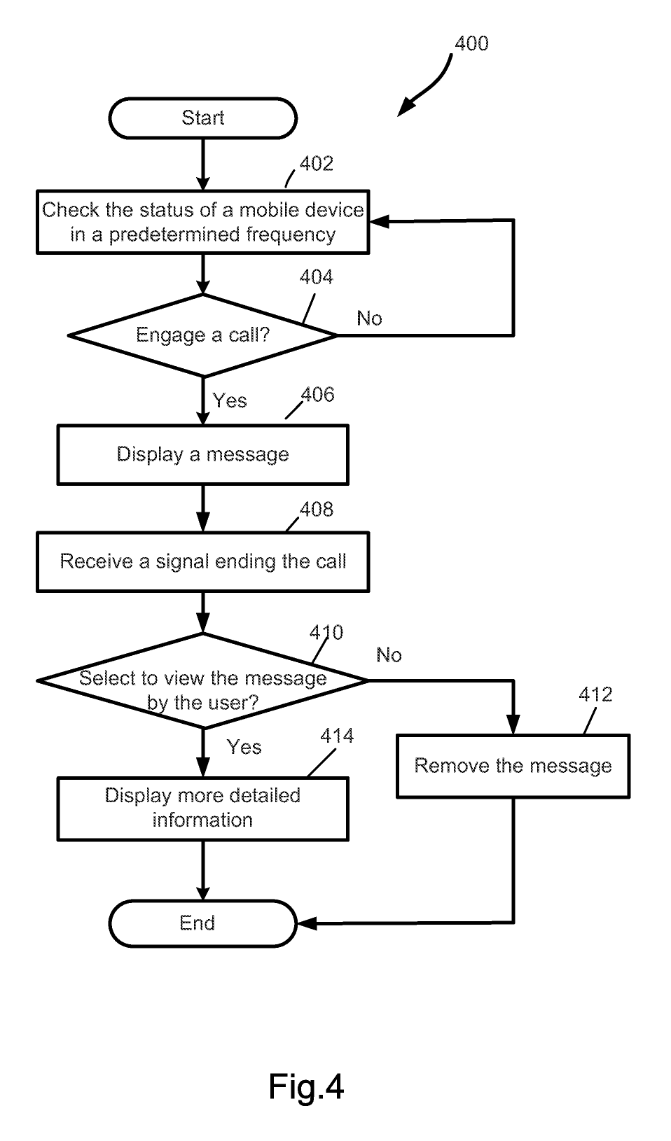

FIG. 4 is a flow diagram of an embodiment for delivering and presenting advertisement messages to a screen of the mobile device during and after the voice communication. A process 400 starts by a step 402; the processor of the mobile device checks the device status in a predetermined frequency. If the processor detects that the device is in a “calling” status at a step 404, an advertisement message is displayed in a step 406. The messages are delivered from the advertising server to the mobile device and are stored in a folder of the file storage system. In a step 408, the call is terminated by the user and a signal associated with the ending the call is received by the processor. The step 410 checks the user's input action. If no user's input action is received, the displayed message is deleted in a step 412 after a predetermined period of time. If the user does select the message, the next level of detailed messages is displayed in a step 414. In an alternative means, a plurality of user selectable items is displayed and the user can select at least one icon for further information.

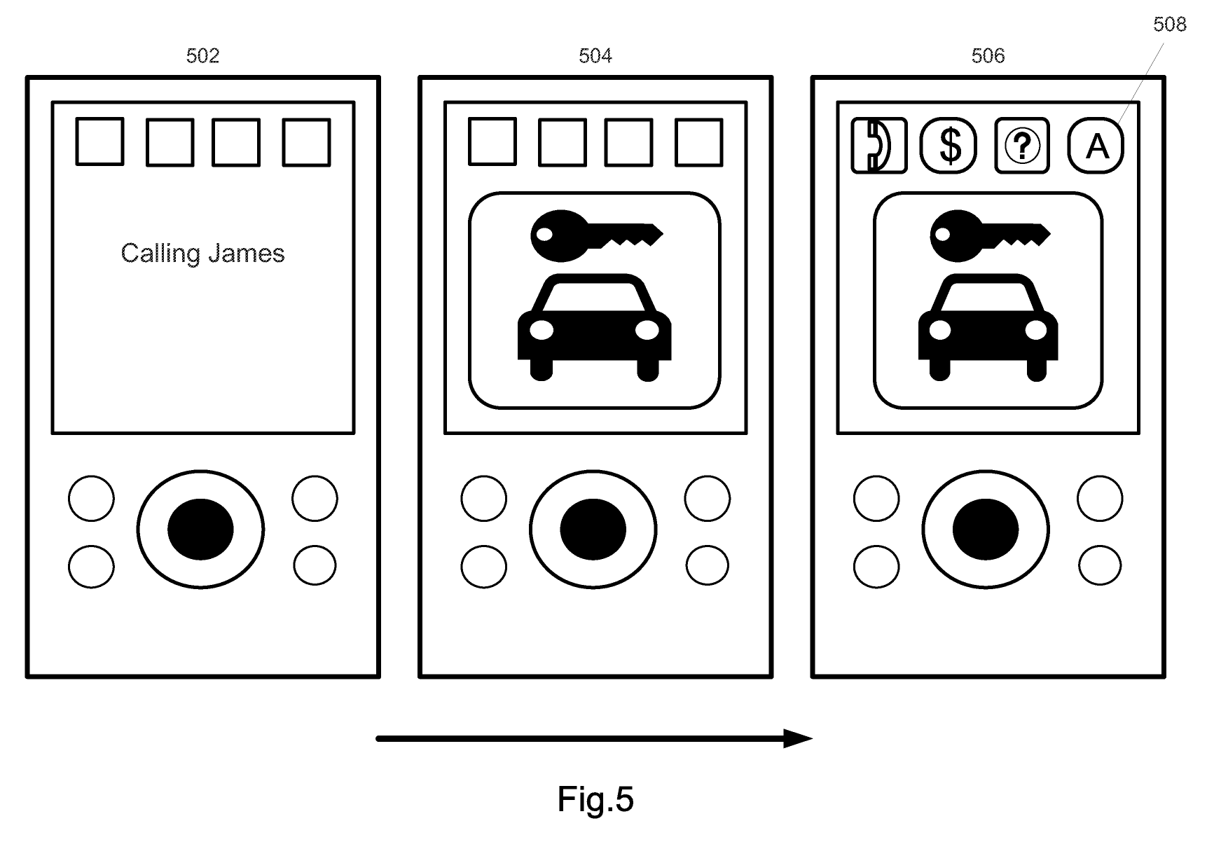

FIG. 5 is a schematic diagram of another embodiment showing a series of display screens changing from a default screen 502 for the mobile device in a calling status to a screen 504 with a displayed message and further to a screen 506 with more user selectable icons for the next level of detailed information and in particularly an icon 508 for other advertisement messages. In such an embodiment, the icon 508 provides an option for the user to navigate into a file folder containing sub-categories of other advertisement messages.

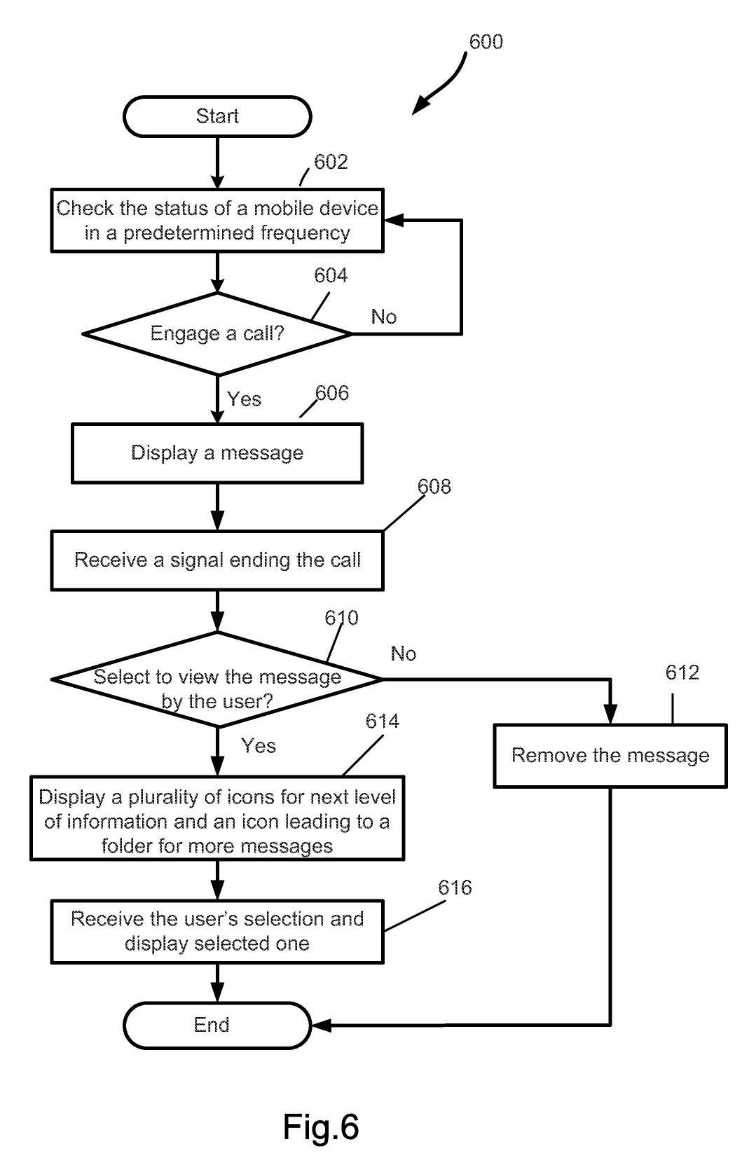

FIG. 6 is a flow diagram of the embodiment as illustrated in FIG. 5 for delivering and presenting advertisement messages to a screen of the mobile device during and after the voice communication, wherein the displayed message includes an icon for other advertisement messages. A process 600 is similar to process 400 from the step 602 to the step 612. The step 614 describes a process that a plurality of user selectable icons is presented to the user for the next level of detailed information. The step 614 includes presenting a specific icon which contains a list of other advertisement messages. It should be noted that the icon may include a user interface with multiple levels of hierarchy to organize and present other advertisement messages to the user.

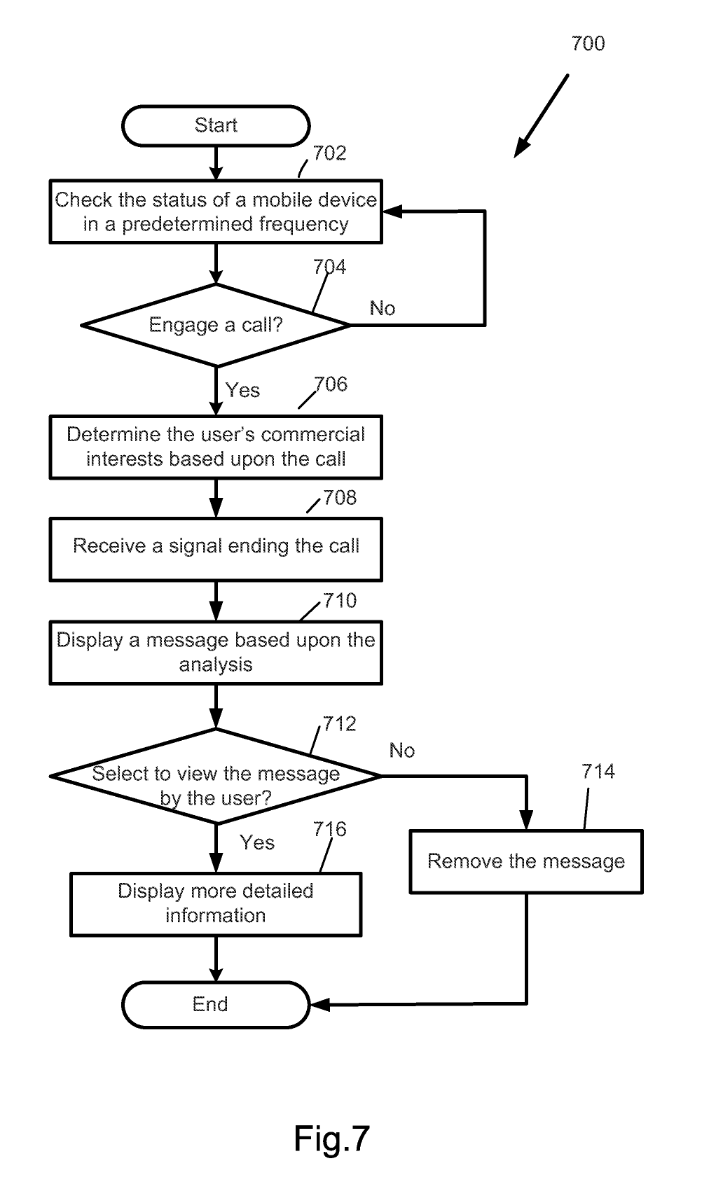

FIG. 7 is a flow diagram of still another embodiment for delivering and presenting advertisement messages to a screen of the mobile device during and after the voice communication, wherein the displayed message is determined based upon the analysis of contents of the voice communication. A process 700 starts by a step 702; the processor of the mobile device checks the device status in a predetermined frequency. If the processor detects that the device is in a “calling” status at a step 704, a voice recognition software module is used to convert the spoken words into text and a software module is used to analyze the contents of the call and to determine the user's commercial interests in a step 706. In a step 708, the call is terminated by the user and a signal associated with the ending of the call is received by the processor. An advertisement message is then displayed on the screen in a step 710 based upon the result of the analysis. The step 712 checks the user's input action. If no user's input action is received, the displayed message is deleted in a step 714 after a predetermined period of time. If the user does select the message, the next level of detailed messages is displayed in a step 716. In an alternative means, a plurality of user selectable items is displayed and the user can select at least one icon for further information.

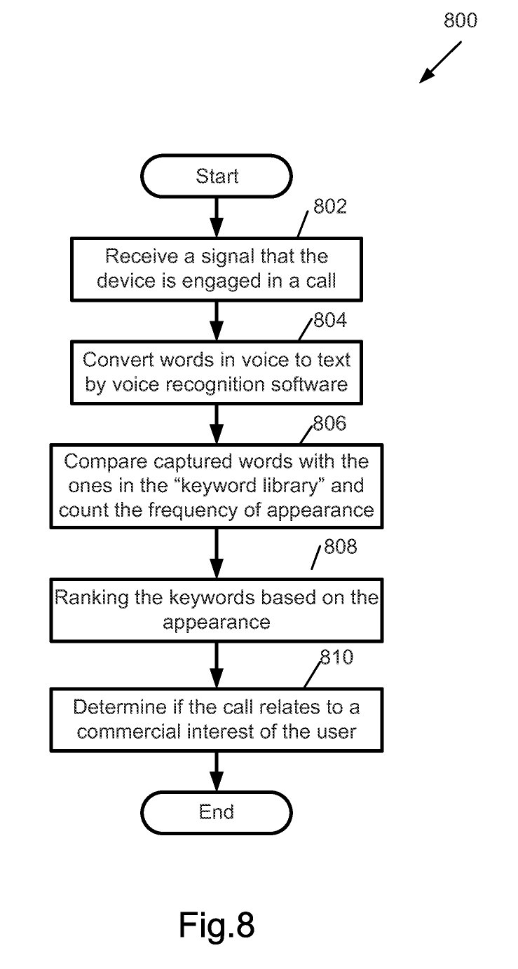

FIG. 8 is a flow diagram of a process for determining a user's commercial interests. The process 800 starts with a step 802 that the processor checks the status of the mobile device in a predetermined frequency. If a signal is received that the device is in a “calling” status, a software module is used in a step 804 to convert the words used in the voice communication into text form by employing a voice recognition software module. The recorded words are then compared to a list of words in a file. The words are selected to represent typical commercial interests of an average user. For example, the file may include words such as, for example, restaurants, bars, theaters, clubs, cars, vacation destination etc. Further, the file may include names of local restaurants, bars and brand names of cars and other merchant items. The captured words from the voice communication are compared with the words in the file in a step 806. A successful match is counted as a successful event. The successful events are counted and ranked for the words. The top ranked words are used to determine the commercial interest of the user in a step 808. The message is then displayed based upon the commercial interests determined by the analyzing of the content of the voice communication. It should be noted that not every voice communication can indicate a commercial interest of the user. As a supplementary means, the user's personal profile and the user's location determined by a GPS device integrated with the mobile device can be used to help to generate a targeted advertisement messages together with the method of the “keyword analyzer”.

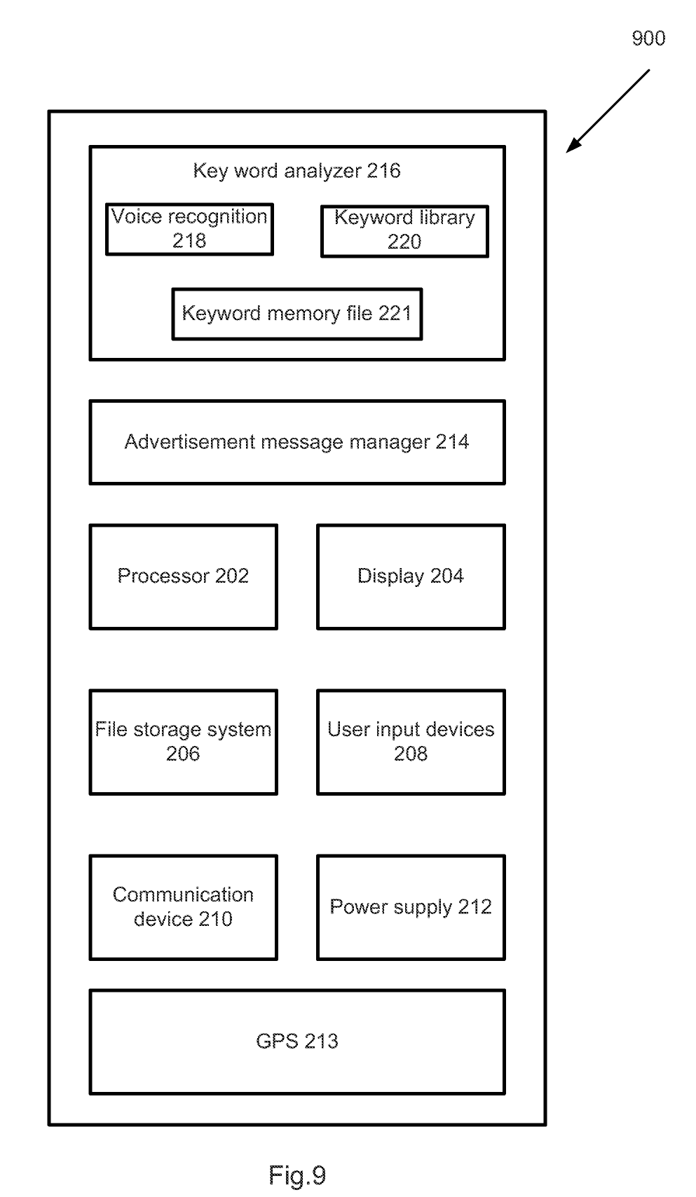

FIG. 9 is a schematic diagram of the mobile communication device according to another embodiment. A keyword memory file 221 is added in the device to store extracted keywords from the voice communications for a predetermined period time. For example, keywords and their frequencies of appearance from the user voice communications over one month may be recorded in the file 221. The user's commercial interest could be determined more accurately with an increased sample size of the recorded keywords. The user's commercial interests may be determined by ranking the frequency of appearance. The user's commercial interest may also be determined by ranking an increased rate of appearance of all keywords in the keyword memory file 221.

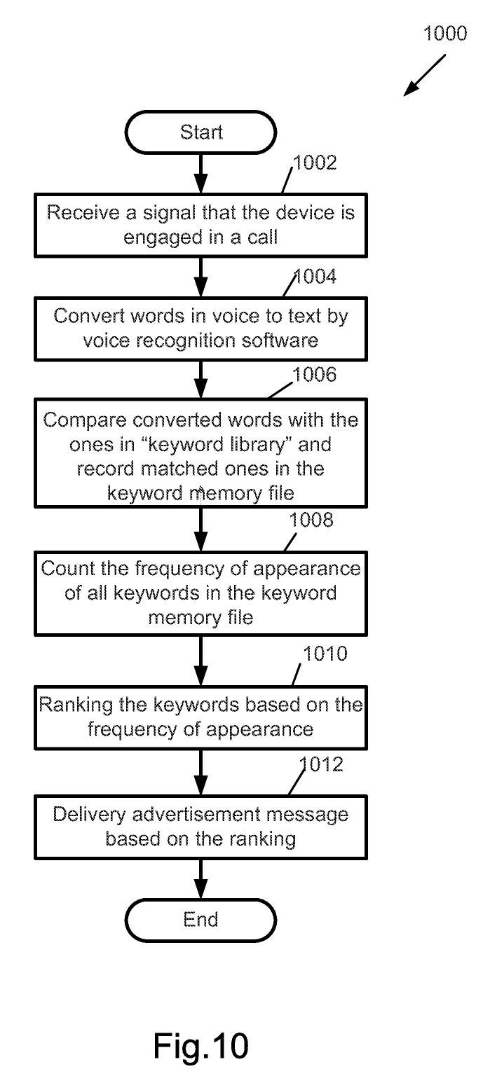

FIG. 10 is a flow diagram illustrating a process that an advertisement message is delivered based on ranking of frequencies of appearance of all keywords in the keyword memory file 221. Process 1000 starts with step 1002 that the processor 202 checks the status of the mobile device 900 in a predetermined frequency. In step 1004, the content of the voice communication is converted to a text form after a signal is received indicating the device 900 is in a “calling” status. The conversion is accomplished by the voice recognition software module 218. The recorded words from the voice communication are compared with the words in the keyword library in step 1006. A successful match is counted as a successful event. The keyword and the frequency of its appearance is recorded in the keyword memory file 221. The frequencies of appearance of all keywords in the keyword memory file 221 are counted over a predetermined period of time in step 1008. All keywords are ranked in step 1010 according to their frequencies of the appearance. An advertisement message is delivered in step 1012 according to the ranking determined in step 1010.

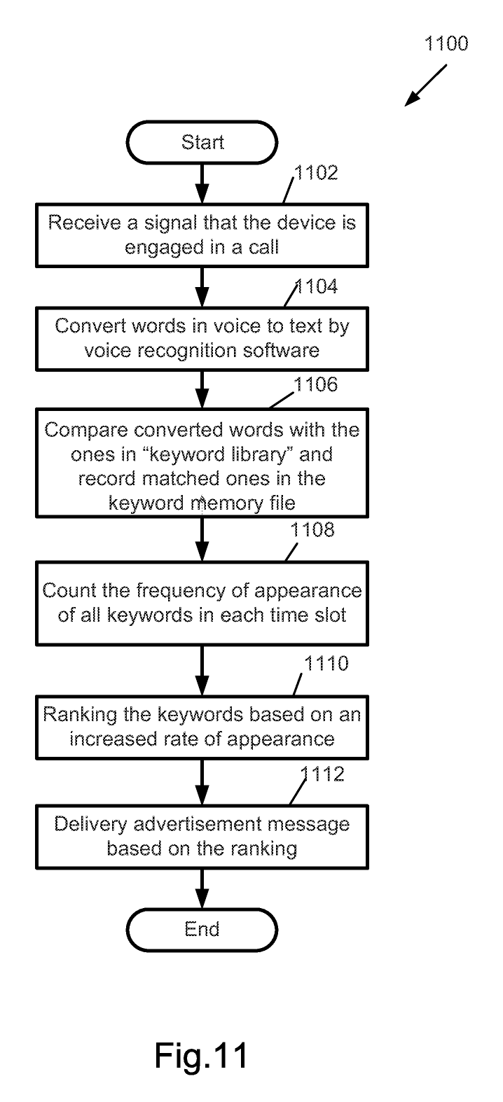

FIG. 11 is a flow diagram illustrating a process that an advertisement message is delivered based on ranking of keywords according to the increased rate of appearance over a predetermined period of time. Process 1100 starts with step 1102 that the processor 202 checks the status of the mobile device 900 in a predetermined frequency. In step 1004, the content of the voice communication is converted to a text form after a signal is received indicating the device 900 is in a “calling” status. The conversion is accomplished by the voice recognition software module 218. The captured words from the voice communication are compared with the words in the keyword library in step 1106. A successful match is counted as a successful event. The predetermined period of time is divided into multiple slots of equal length. For example, if the predetermined period of time is 4 weeks, each week may be a slot. The keywords and their frequency of appearance in each time slot is counted in step 1108. The keywords are ranked based on the increased rate of appearance in step 1110. An increased rate of appearance is defined as the number of successful events in the current slot minus the number of the successful events in the previous slot.

All keywords are ranked in step 1110 according to the increased rate of appearance. An advertisement message is then delivered in step 1112 according to the ranking determined in step 1110.

1. A method of rendering an advertisement message to a user using a mobile device comprising a processor, a communication device, a display screen and an input device, the method comprising:
receiving a signal by the processor from the communication device indicating said mobile device is being used by the user for a voice communication with another user through a communication network;
converting a content of the voice communication into a plurality of words in text forms using a voice recognition software module in the mobile device;
determining keywords and frequencies of their appearance according to a keyword library stored in a file storage system of the mobile device;
adding said determined keywords and the frequencies in a data file stored in a file storage system of the mobile device, wherein said data file further includes recorded keywords and frequency of their appearances during previous voice communications over a predetermined period of time.
ranking all keywords in the data file according to the frequencies of their appearance over said predetermined period of time; and
displaying on the display screen an advertisement message according to said ranking.

2. The method as recited in claim 1, wherein said advertisement message is displayed immediately after the voice communication is completed.

3. The method as recited in claim 1, wherein said advertisement message is displayed during the voice communication.

4. The method as recited in claim 1, wherein said method further comprising:
receiving the user's input action through the input device to select the displayed message for a review; and
displaying on the displayed screen next level of details about the selected message.

5. The method as recited in claim 1, wherein said method further comprising removing the displayed message if said user's input is not received after a predetermined period of time of terminating said voice communication.

6. The method as recited in claim 1, wherein said advertisement message may be the user's location dependent, wherein the user's location may be determined by a location determining means in said mobile device.

7. The method as recited in claim 6, wherein said location determining means further comprising a GPS.

8. The method as recited in claim 1, wherein said advertisement message may also depend on the user's personal profile.

9. A method of rendering advertisement messages to a user using a mobile device comprising a processor, a communication device, a display screen and an input device, the method comprising:
receiving a signal by the processor from the communication device indicating said mobile device is being used by the user for a voice communication with another user through a communication network;
converting a content of the voice communication into a plurality of words in text forms using a voice recognition software module in the mobile device;
determining keywords and frequencies of their appearance according to a keyword library stored in a file storage system of the mobile device;
adding said determined keywords and the frequencies in a data file stored in a file storage system of the mobile device, wherein said data file further includes recorded keywords and frequency of their appearances during each of previous voice communication events for a predetermined period of time.
ranking all keywords in the data file according to an increased rate of appearance; and
displaying on the display screen an advertisement message according to said ranking.

10. The method as recited in claim 9, wherein said advertisement message is displayed immediately after the voice communication is completed.

11. The method as recited in claim 9, wherein said advertisement message is displayed during the voice communication.

12. The method as recited in claim 9, wherein said method further comprising:
receiving the user's input action through the input device to select the displayed message for a review; and
displaying on the displayed screen next level of details about the selected message.

13. The method as recited in claim 9, wherein said method further comprising removing the displayed message if said user's input is not received after a predetermined period of time of terminating said voice communication.

14. The method as recited in claim 9, wherein said advertisement message may be the user's location dependent, wherein the user's location may be determined by a location determining means in said mobile device.

15. The method as recited in claim 14, wherein said location determining means further comprising a GPS.

16. The method as recited in claim 9, wherein said advertisement message may also depend on the user's personal profile.

17. A method of identifying a user's commercial interests by analyzing recorded contents of the user's voice communication by using a mobile device comprising a processor, communication device, a display screen, a file storage system and a user input device, the method comprising:
recording the user's voice communication content with other users over a predetermined period of time using the mobile device;
converting the recorded contents into a plurality of words using a voice recognition software module in the mobile device;
comparing the converted words with words in a pre-stored file stored in the file storage system;
identifying a match between a word from said voice communication and a word from the pre-stored file as one successful event;
ranking the words according to an increased rate of appearance; and
determining the user's commercial interest according to a result of the ranking.

18. The method as recited in claim 17, wherein said pre-stored file further comprising a list of words representing various groups of retailers.

19. The method as recited in claim 17, wherein said pre-stored file further comprising a list of words representing names of retailers.

20. The method as recited in claim 17, wherein said method of determining the user's commercial interest further comprising ranking said words according to said increased rate of appearance and frequency of appearance over the predetermined period of time.
